(19) United States
(12) Patent Application Publication
(10) Pub. No.: US 2025/0142562 A1
(43) Pub. Date: May 1, 2025

(54) CONFIGURED GRANT TRANSMISSIONS WITH MULTIPLE TRANSMIT RECEIVE POINTS

(71) Applicant: QUALCOMM Incorporated, San Diego, CA (US)

(72) Inventors: Fang YUAN, Beijing (CN); Yan ZHOU, San Diego, CA (US); Wooseok NAM, San Diego, CA (US); Tao LUO, San Diego, CA (US)

(21) Appl. No.: 18/706,162

(22) PCT Filed: Jan. 21, 2022
(86) PCT No.: PCT/CN2022/073119

§ 371 Date: Apr. 30, 2024

(51) Int. Cl. H04W 72/1268; H04L 5/00; H04W 72/0453

(52) U.S. Cl. CPC H04W 72/1268; H04L 5/0044; H04L 5/0051; H04W 72/0453

(57) ABSTRACT

Various aspects of the present disclosure generally relate to wireless communication. In some aspects. a user equipment (UE) may receive a configuration that configures the UE for type 1 or type 2 configured grant physical uplink shared channel (CG-PUSCH) communications for multiple transmit receive points. The UE may transmit frequency division multiplexed or spatial division multiplexed PUSCH transmissions based at least in part on the configuration. Numerous other aspects are described.

### FIELD OF THE DISCLOSURE

Aspects of the present disclosure generally relate to wireless communication and to techniques and apparatuses for configured grant transmissions with multiple transmit receive points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration that configures the UE for type 1 or type 2 configured grant physical uplink shared channel (CG-PUSCH) communications for multiple transmit receive points (TRPs). The method may include transmitting frequency division multiplexed (FDMed) or spatial division multiplexed (SDMed) PUSCH transmissions based at least in part on the configuration.

Some aspects described herein relate to a method of wireless communication performed by a base station. The method may include transmitting, to a UE, a configuration that configures the UE for type 1 or type 2 CG-PUSCH communications for multiple TRPs. The method may include receiving, at one or more of a first TRP or a second TRP of the base station, FDMed or SDMed PUSCH transmissions based at least in part on the configuration.

Some aspects described herein relate to a UE for wireless communication. The UE may include a memory and one or more processors coupled to the memory. The one or more processors may be configured to receive a configuration that configures the UE for type 1 or type 2 CG-PUSCH communications for multiple TRPs. The one or more processors may be configured to transmit FDMed or SDMed PUSCH transmissions based at least in part on the configuration.

Some aspects described herein relate to a base station for wireless communication. The base station may include a memory and one or more processors coupled to the memory. The one or more processors may be configured to transmit, to a UE, a configuration that configures the UE for type 1 or type 2 CG-PUSCH communications for multiple TRPs. The one or more processors may be configured to receive, at one or more of a first TRP or a second TRP of the base station, FDMed or SDMed PUSCH transmissions based at least in part on the configuration.

Some aspects described herein relate to a non-transitory computer-readable medium that stores a set of instructions for wireless communication by a UE. The set of instructions, when executed by one or more processors of the UE, may cause the UE to receive a configuration that configures the UE for type 1 or type 2 CG-PUSCH communications for multiple TRPs. The set of instructions, when executed by one or more processors of the UE, may cause the UE to transmit FDMed or SDMed PUSCH transmissions based at least in part on the configuration.

Some aspects described herein relate to a non-transitory computer-readable medium that stores a set of instructions for wireless communication by a base station. The set of instructions, when executed by one or more processors of the base station, may cause the base station to transmit, to a UE, a configuration that configures the UE for type 1 or type 2 CG-PUSCH communications for multiple TRPs. The set of instructions, when executed by one or more processors of the base station, may cause the base station to receive, at one or more of a first TRP or a second TRP of the base station, FDMed or SDMed PUSCH transmissions based at least in part on the configuration.

Some aspects described herein relate to an apparatus for wireless communication. The apparatus may include means for receiving a configuration that configures the apparatus for type 1 or type 2 CG-PUSCH communications for multiple TRPs. The apparatus may include means for transmitting FDMed or SDMed PUSCH transmissions based at least in part on the configuration.

Some aspects described herein relate to an apparatus for wireless communication. The apparatus may include means for transmitting, to a UE, a configuration that configures the UE for type 1 or type 2 CG-PUSCH communications for multiple TRPs. The apparatus may include means for receiving, at one or more of a first TRP or a second TRP of the base station, FDMed or SDMed PUSCH transmissions based at least in part on the configuration.

Aspects generally include a method, apparatus, system, computer program product, non-transitory computer-readable medium, UE, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example logical architecture of a distributed random access network, in accordance with the present disclosure.

FIG. 4 is a diagram illustrating an example of multiple transmit receive point (TRP) communication, in accordance with the present disclosure.

FIG. 5 is a diagram illustrating an example of uplink configured grant (CG) communication, in accordance with the present disclosure.

FIG. 6 is a diagram illustrating an example of redundancy version (RV) cycling based on uplink transmission occasions, in accordance with the present disclosure.

FIG. 7 is a diagram illustrating an example of RV sequences, in accordance with the present disclosure.

FIG. 8 is a diagram illustrating an example of supporting CG physical uplink shared channel transmissions with multiple TRPs for RV sequences, in accordance with the present disclosure.

FIG. 9 is a diagram illustrating an example of transmissions to TRPs in transmission occasions, in accordance with the present disclosure.

FIG. 10 is a diagram illustrating an example of physical channels and reference signals in a wireless network, in accordance with the present disclosure.

FIG. 11 is a diagram illustrating an example of associating phase tracking reference signal ports with demodulation reference signal ports, in accordance with the present disclosure.

FIG. 12 is a diagram illustrating an example process performed, for example, by a UE, in accordance with the present disclosure.

FIG. 13 is a diagram illustrating an example process performed, for example, by a base station, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

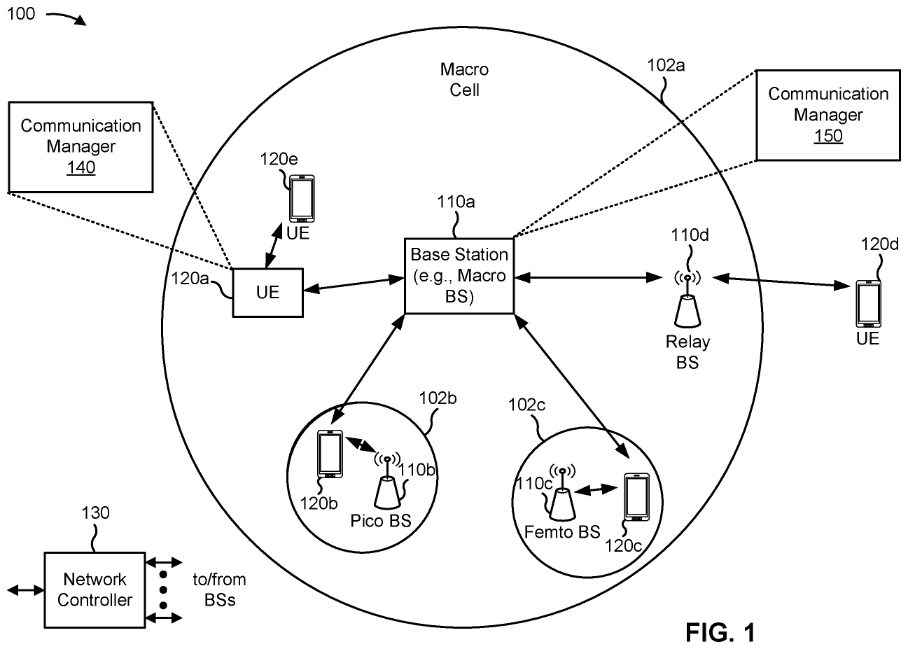

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration that configures the UE for type 1 or type 2 configured grant physical uplink shared channel (CG-PUSCH) communications for multiple TRPs. The communication manager 140 may transmit frequency division multiplexed (FDMed) or spatial division multiplexed (SDMed) PUSCH transmissions based at least in part on the configuration. Additionally, or alternatively, the communication manager 140 may perform one or more other operations described herein.

In some aspects, the base station 110 may include a communication manager 150. As described in more detail elsewhere herein, the communication manager 150 may transmit, to a UE, a configuration that configures the UE for type 1 or type 2 CG-PUSCH communications for multiple TRPs. The communication manager 150 may receive, at one or more of a first TRP or a second TRP of the base station, FDMed or SDMed PUSCH transmissions based at least in part on the configuration. In some aspects, the communication manager 150 may use an DCI for the multiple TRPs. Additionally, or alternatively, the communication manager 150 may perform one or more other operations described herein.

As indicated above, FIG. 1 is provided as an example. Other examples may differ from what is described with regard to FIG. 1.

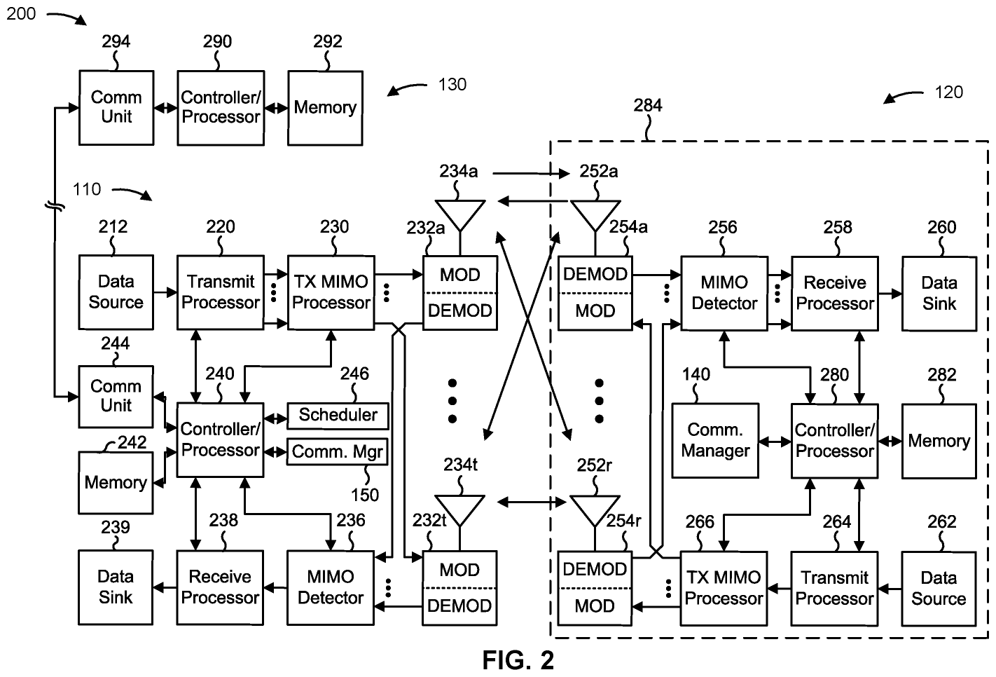

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

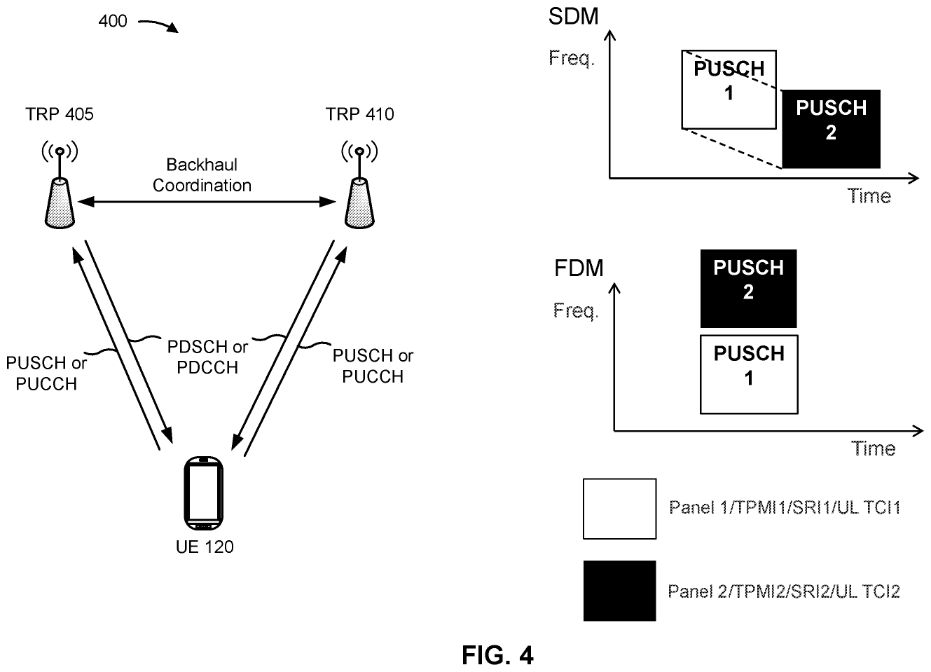

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM) and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-15).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-15).

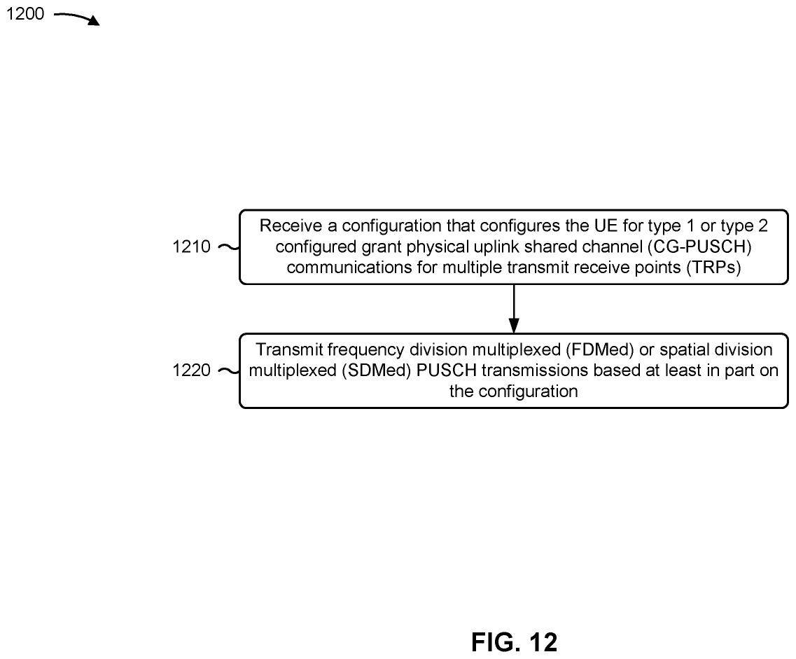

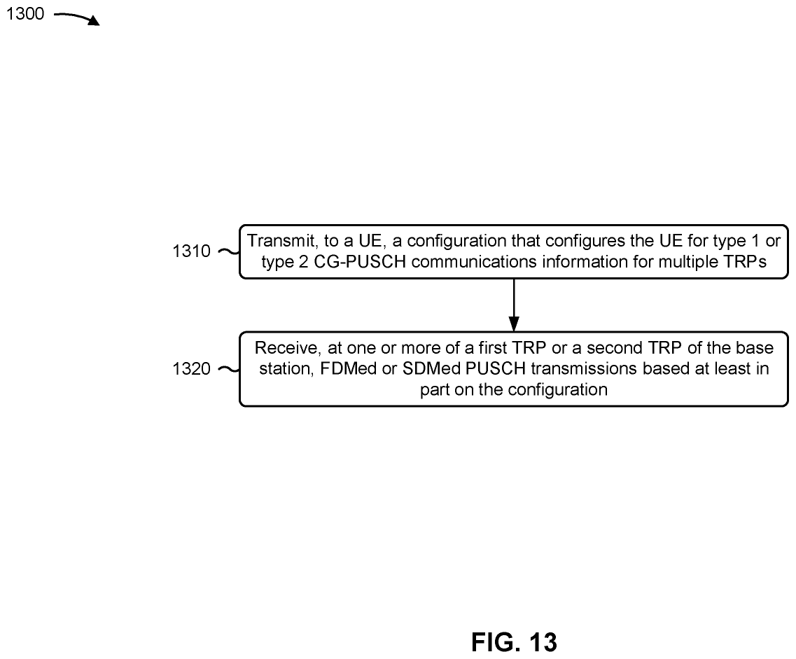

The controller/processor 240 of the base station 110, the controller/processor 280 of the UE 120, and/or any other component(s) of FIG. 2 may perform one or more techniques associated with CG-PUSCH communications with multiple TRPs, such as multiple CG-PUSCH communications that are transmitted simultaneously, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving a configuration that configures the UE for type 1 or type 2 CG-PUSCH communications for multiple TRPs; and/or means for transmitting FDMed or SDMed PUSCH transmissions based at least in part on the configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a UE, a configuration that configures the UE for type 1 or type 2 CG-PUSCH communications for multiple TRPs; and/or means for receiving, at one or more of a first TRP or a second TRP of the base station, FDMed or SDMed PUSCH transmissions based at least in part on the configuration. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

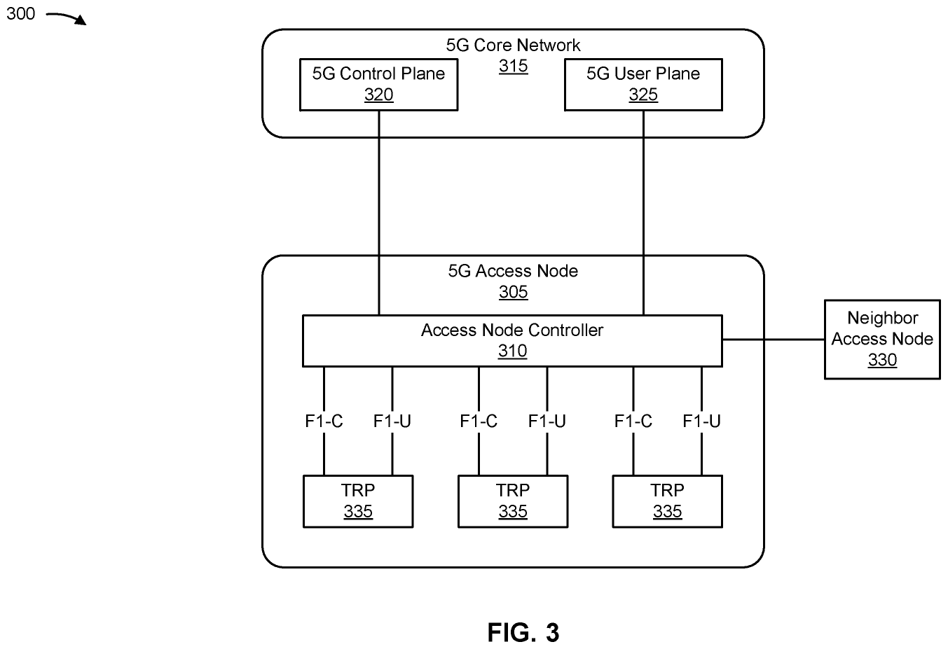

FIG. 3 illustrates an example logical architecture of a distributed random access network (RAN) 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally, or alternatively, multiple TRPs 335 may be included in a single base station 110. In some aspects, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some aspects, multiple TRPs 335 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 335 may be configured to individually (e.g., using dynamic selection) or jointly (e.g., using joint transmission with one or more other TRPs 335) serve traffic to a UE 120.

As indicated above, FIG. 3 is provided as an example. Other examples may differ from what was described with regard to FIG. 3.

FIG. 4 is a diagram illustrating an example 400 of multiple TRP (multi-TRP) communication (sometimes referred to as multi-panel communication), in accordance with the present disclosure. As shown in FIG. 4, multiple TRPs 405 and 410 may communicate with the same UE 120. TRP 405 and TRP 410 may correspond to a TRP 335 described above in connection with FIG. 3.

The multiple TRPs 405 and 410 may communicate with the same UE 120 in a coordinated manner (e.g., using coordinated multipoint transmissions) to improve reliability and/or increase throughput. TRP 405 and TRP 410 may coordinate such communications via an interface between TRP 405 and TRP 410 (e.g., a backhaul interface and/or an access node controller 310). The interface may have a smaller delay and/or higher capacity when TRP 405 and TRP 410 are co-located at the same base station 110 (e.g., when TRP 405 and TRP 410 are different antenna arrays or panels of the same base station 110) and may have a larger delay and/or lower capacity (as compared to co-location) when TRP 405 and TRP 410 are located at different base stations 110. The different TRPs 405 and 410 may communicate with the UE 120 using different quasi-co-location (QCL) relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH) or a single PUSCH. In this case, TRP 405 and TRP 410 may transmit communications to the UE 120 on the same PDSCH. For example, a communication may be transmitted using a single codeword with different spatial layers for different TRPs 405 and 410 (e.g., where one codeword maps to a first set of layers transmitted by TRP 405 and maps to a second set of layers transmitted by TRP 410). As another example, a communication may be transmitted using multiple codewords, where different codewords are transmitted by different TRPs 405 (e.g., using different sets of layers). In either case, TRP 405 and TRP 410 may use different QCL relationships (e.g., different TCI states) for different DMRS ports corresponding to different layers. For example, TRP 405 may use a first QCL relationship or a first TCI state for a first set of DMRS ports corresponding to a first set of layers, and TRP 410 may use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs or PUSCHs (e.g., one PDCCH for each PDSCH or PUSCH). In this case, a first PDCCH may schedule a first codeword to be transmitted by TRP 405, and a second PDCCH may schedule a second codeword to be transmitted by TRP 410. Furthermore, first DCI (e.g., transmitted by TRP 405) may schedule a first PDSCH or PUSCH communication associated with a first set of DMRS ports with a first QCL relationship (e.g., indicated by a first TCI state) for TRP 405, and second DCI (e.g., transmitted by TRP 410) may schedule a second PDSCH or PUSCH communication associated with a second set of DMRS ports with a second QCL relationship (e.g., indicated by a second TCI state) for TRP 410. In this case, DCI (e.g., having DCI format 1_0 or DCI format 1_1) may indicate a corresponding TCI state for TRP 405 or TRP 410 corresponding to the DCI. The TCI field of a DCI indicates the corresponding TCI state (e.g., the TCI field of the first DCI indicates the first TCI state and the TCI field of the second DCI indicates the second TCI state).

The base station 110 may transmit, to the UE 120, DCI that schedules multiple communications for the UE 120. The multiple communications may be scheduled for at least two different cells. In some cases, a cell may be referred to as a component carrier (CC). In some cases, DCI that schedules a communication for a cell via which the DCI is transmitted may be referred to as self-carrier (or self-cell) scheduling DCI. In some cases, DCI that schedules a communication for a cell via which the DCI is transmitted may be referred to as cross-carrier (or cross-cell) scheduling DCI. In some aspects, the DCI may be cross-carrier scheduling DCI, and may or may not be self-carrier scheduling DCI. In some aspects, the DCI that carries communications in at least two cells may be referred to as combination DCI.

The DCI may be a single DCI (sDCI) that schedules a communication for a first cell (TRP 405) that carries (or does not carry) the DCI and a communication for a second cell (TRP 410) that does not carry the DCI. The sDCI may be used to schedule and/or activate resources for multiple TRPs with a single DCI. In some aspects, the sDCI may schedule communications on a different number of cells (e.g., two cells, four cells, five cells, and so on). The number of cells may be greater than or equal to two.

A communication scheduled by the sDCI may include a PDSCH communication or a PUSCH communication. For a data communication, the sDCI may schedule a single transport block (TB) across multiple cells or may separately schedule multiple TBs in the multiple cells. Additionally, or alternatively, a communication scheduled by the sDCI may include a reference signal, such as a channel state information reference signal (CSI-RS) or a sounding reference signal (SRS). For a reference signal, the sDCI may trigger a single resource for reference signal transmission across multiple cells or may separately schedule multiple resources for reference signal transmission in the multiple cells. In some cases, scheduling information in the sDCI may be indicated once and reused for multiple communications (e.g., on different cells), such as an MCS, a resource to be used for acknowledgement (ACK) or negative acknowledgement (NACK) of a communication scheduled by the DCI, and/or a resource allocation for a scheduled communication, to conserve signaling overhead.

In some aspects, the UE 120 may transmit two PUSCH communications (shown as PUSCH1 and PUSCH 2) to a first TRP and a second TRP simultaneously. PUSCH1 and PUSCH2 may be the same TB or the same payload. The UE 120 may transmit PUSCH1 to the first TRP using a first antenna panel indicated with a first transmit precoding matrix index (TPMI1) and/or a first SRS resource indicator (SRI1) with a first uplink TCI (TCI1), and PUSCH2 to the second TRP using a second antenna panel indicated with a second TPMI (TPMI2) and/or a second SRI (SRI2) with a second uplink TCI (TCI2). For SDM PUSCH transmissions, the UE 120 may transmit PUSCH1 and PUSCH2 simultaneously with spatial diversity (in different transmission spaces). For time division multiplexing (TDM) PUSCH transmissions, the UE 120 may transmit PUSCH1 and PUSCH2 simultaneously with frequency diversity (at different frequencies). In other words, the UE 120 may use single downlink control information (sDCI) multi-TRP (mTRP) operations with FDMed or SDMed PUSCH transmissions.

As indicated above, FIG. 4 is provided as an example. Other examples may differ from what is described with respect to FIG. 4.

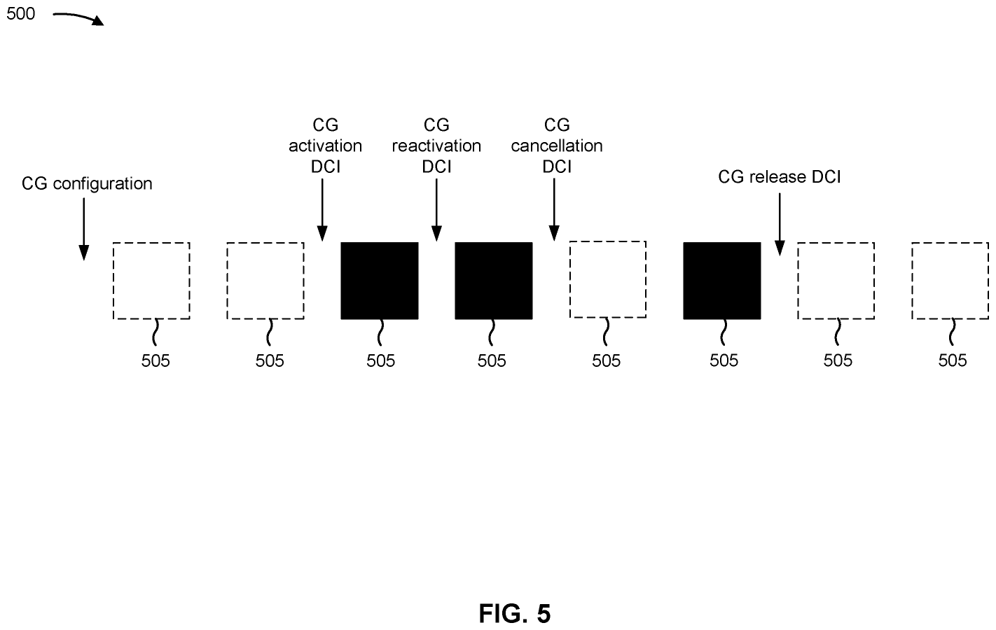

FIG. 5 is a diagram illustrating an example 500 of uplink configured grant (CG) communication, in accordance with the present disclosure. CG communications may include periodic uplink communications that are configured for a UE (e.g., a UE 120), such that a base station (e.g., base station 110) does not need to send separate DCI to schedule each uplink communication, thereby conserving signaling overhead.

As shown in example 500, the UE 120 may be configured with a CG configuration for CG PUSCH communications. For example, the UE 120 may receive the CG configuration via an RRC message transmitted by a base station. The CG configuration may indicate a resource allocation associated with CG PUSCH communications (e.g., in a time domain, frequency domain, spatial domain, and/or code domain) and a periodicity at which the resource allocation is repeated, resulting in periodically recurring scheduled CG occasions 505 for the UE 120. In some examples, the CG configuration may identify a resource pool or multiple resource pools that are available to the UE 120 for an uplink transmission. The CG configuration may configure contention-free CG communications (e.g., where resources are dedicated for the UE 120 to transmit uplink communications) or contention-based CG communications (e.g., where the UE 120 contends for access to a channel in the configured resource allocation, such as by using a channel access procedure or a channel sensing procedure).

The base station 110 may transmit CG activation DCI to the UE 120 to activate the CG configuration for the UE 120. The base station 110 may indicate, in the CG activation DCI, communication parameters, such as an MCS, a resource block (RB) allocation, and/or antenna ports, for the CG PUSCH communications to be transmitted in the scheduled CG occasions 505. The UE 120 may begin transmitting in the CG occasions 505 based at least in part on receiving the CG activation DCI. For example, beginning with a next scheduled CG occasion 505 subsequent to receiving the CG activation DCI, the UE 120 may transmit a PUSCH communication in the scheduled CG occasions 505 using the communication parameters indicated in the CG activation DCI. The UE 120 may refrain from transmitting in configured CG occasions 505 prior to receiving the CG activation DCI.

The base station 110 may transmit CG reactivation DCI to the UE 120 to change the communication parameters for the CG PUSCH communications. Based at least in part on receiving the CG reactivation DCI, the UE 120 may begin transmitting in the scheduled CG occasions 505 using the communication parameters indicated in the CG reactivation DCI. For example, beginning with a next scheduled CG occasion 505 subsequent to receiving the CG reactivation DCI, the UE 120 may transmit PUSCH communications in the scheduled CG occasions 505 based at least in part on the communication parameters indicated in the CG reactivation DCI.

In some cases, such as when the base station 110 needs to override a scheduled CG communication for a higher priority communication, the base station 110 may transmit CG cancellation DCI to the UE 120 to temporarily cancel or deactivate one or more subsequent CG occasions 505 for the UE 120. The CG cancellation DCI may deactivate only a subsequent single CG occasion 505 or a subsequent N CG occasions 505 (where Nis an integer greater than one). CG occasions 505 after the one or more (e.g., N) CG occasions 505 subsequent to the CG cancellation DCI may remain activated. Based at least in part on receiving the CG cancellation DCI, the UE 120 may refrain from transmitting in the one or more (e.g., N) CG occasions 505 subsequent to receiving the CG cancellation DCI. As shown in example 500, the CG cancellation DCI cancels one subsequent CG occasion 505 for the UE 120. After the CG occasion 505 (or N CG occasions) subsequent to receiving the CG cancellation DCI, the UE 120 may automatically resume transmission in the scheduled CG occasions 505.

The base station 110 may transmit CG release DCI to the UE 120 to deactivate the CG configuration for the UE 120. The UE 120 may stop transmitting in the scheduled CG occasions 505 based at least in part on receiving the CG release DCI. For example, the UE 120 may refrain from transmitting in any scheduled CG occasions 505 until another CG activation DCI is received from the base station 119. Whereas the CG cancellation DCI may deactivate only a subsequent single CG occasion 505 or a subsequent N CG occasions 505, the CG release DCI deactivates all subsequent CG occasions 505 for a given CG configuration for the UE 120 until the given CG configuration is activated again by a new CG activation DCI.

CG may be type 1 or type 2. For type 1 CG, the base station 110 may provide an uplink CG configuration message (with a periodicity for the transmissions using configured time domain resource allocation (TDRA) and frequency domain resource allocation (FDRA)) via a radio resource control (RRC). The UE 120 may then store the uplink CG. The base station 110 may use PDCCH communications (e.g., DCI 0_0 or DCI 0_1) for retransmissions. For type 2 CG, the base station 110 may transmit an uplink CG activation or deactivation signaling via a PDCCH communication (with RRC parameters) and the UE 120 may store or clear an uplink CG based on Layer 1 (L1) signaling (e.g., DCI) indicating uplink CG activation or deactivation. The base station 110 may use a PDCCH communication (e.g., DCI 0_0 or DCI 0_1) to indicate a TDRA or a retransmission.

As indicated above, FIG. 5 is provided as an example. Other examples may differ from what is described with respect to FIG. 5.

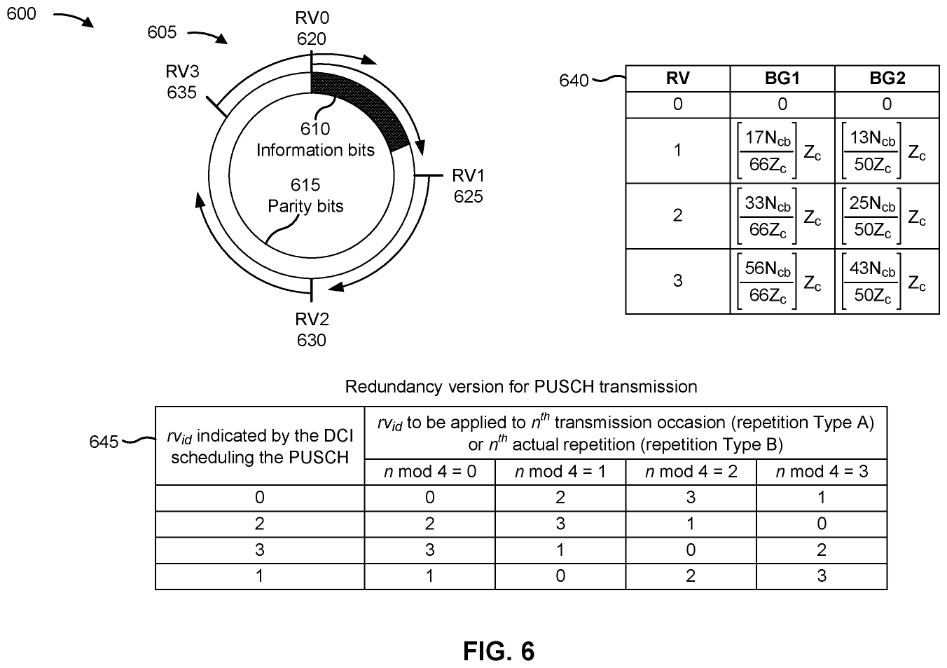

FIG. 6 is a diagram illustrating an example 600 of redundancy version (RV) cycling based on uplink transmission occasions, in accordance with the present disclosure. A UE (e.g., a UE 120) may apply RV cycling to PUSCH repetitions to transmit different RVs of the PUSCH repetition in different transmission occasions.

A “redundancy version” of a PUSCH repetition may refer to a set of encoded bits that are transmitted for that PUSCH repetition. Using RV cycling, the UE 120 may transmit a different set of encoded bits in different PUSCH repetitions. For example, the UE 120 may store bits for an uplink transmission in a circular buffer 605 (e.g., stored in memory of the UE 120). The circular buffer 605 stores information bits 610 and parity bits 615 (sometimes called parity-check bits). The information bits 610 may include the data to be transmitted, and the parity bits 615 may include linear combinations of the data (e.g., of the information bits 610). The UE 120 may encode information bits 610, parity bits 615, or a combination of information bits 610 and parity bits 615 into a set of encoded bits and may transmit the set of encoded bits. The particular bits that are selected to be included in the set of encoded bits for a PUSCH repetition depend on (or are defined by) the RV of that PUSCH repetition.

As an example, the starting bit locations may be defined by a table 640, such as for NR hybrid automatic repeat request (HARQ) using low-density parity-check (LDPC) code. The table 640 defines starting bit locations in the circular buffer 605 for a first base graph (BG1) and a second base graph (BG2). A base graph is a parameter for determining parity bits 615 for a transmission based at least in part on a TB size and a code rate (with BG1 being intended for TBs with a larger TB size, and BG2 being intended for TBs with a smaller TB size). Referring to the table, N_{cb} represents the length of the circular buffer 605 (e.g., the number of bits included in the circular buffer 605), and Z_{c} represents a lifting size, which is based at least in part on the number of information bits 610 and the number of BG columns corresponding to information bits 610.

In some examples, a base station 110 may transmit information, such as an RV index, to the UE 120. For example, the base station 110 may transmit the RV index for a PUSCH communication (e.g., a PUSCH transmission) in DCI that schedules the PUSCH communication. The RV index may indicate a sequence of RVs to be applied to a corresponding sequence of PUSCH transmission occasions (e.g., PUSCH opportunities). The UE 120 may increment a counter n (sometimes called an index n) for each uplink transmission occasion following (or indicated by) the DCI. The UE 120 may use the information transmitted by the base station 110 (e.g., the RV index) and the value of the counter n for a particular transmission occasion to determine an RV to be applied to that transmission occasion.

For example, as shown by table 645, for PUSCH Repetition Type A, if the base station 110 indicates an RV index of 0, then the UE 120 may determine an RV to be applied to an nth transmission occasion (e.g., for PUSCH Repetition Type A) by calculating n mod 4, where mod represents a modulo operation. If n mod 4=0 (e.g., for transmission occasion 0), then the UE 120 applies RV0 to that transmission occasion. If n mod 4=1 (e.g., for transmission occasion 1), then the UE 120 applies RV2 to that transmission occasion. If n mod 4=2 (e.g., for transmission occasion 2), then the UE 120 applies RV3 to that transmission occasion. If n mod 4=3 (e.g., for transmission occasion 3), then the UE 120 applies RV1 to that transmission occasion. As shown, the RV index may have a value of 0, 1, 2, or 3, each of which corresponds to a different sequence of RVs (e.g., a different order for RV0, RV1, RV2, and RV3).

Similarly, for PUSCH Repetition Type B, if the base station 110 indicates an RV index of 0, then the UE 120 may determine an RV to be applied to an nth actual repetition (e.g., of PUSCH Repetition Type B) by calculating n mod 4, where mod represents a modulo operation. If n mod 4=0 (e.g., for actual repetition 0), then the UE 120 applies RV0 to that actual repetition. If n mod 4=1 (e.g., for actual repetition 1), then the UE 120 applies RV2 to that actual repetition. If n mod 4=2 (e.g., for actual repetition 2), then the UE 120 applies RV3 to that actual repetitions. If n mod 4=3 (e.g., for actual repetition 3), then the UE 120 applies RV1 to that actual repetition.

As indicated above, FIG. 6 is provided as an example. Other examples may differ from what is described with respect to FIG. 6. For example, the RV cycling technique shown in table 645 is one example of an RV cycling technique, and other RV cycling techniques maybe used.

The UE 120 may use rate matching to transmit a TB to a TRP. Rate matching involves mapping a payload of encoded bits to symbols (within a TTI). This may include mapping different subsets of the encoded bits to transmission resources (e.g., RBs and ports), because the encoded bits may be too large for an RB set and the UE 120 may have to map a subset of the encoded bits. The subset of encoded bits may be correspond to an RV. The RV may be associated with a starting point and a length for the subset of encoded bits. Different RVs may have different amounts of encoded bits that are repeated (or punctured) for an RV set. The amount of bits that are mapped to RBs/symbols may correspond to a rate. The rate may vary for different FDRA parts (separate rate matchings for each FDRA part) or may be the same (single rate matching). The separate rate matchings for different TRPs may increase a reliability of the transmissions.

As indicated above, FIG. 6 is provided as an example. Other examples may differ from what is described with regard to FIG. 6.

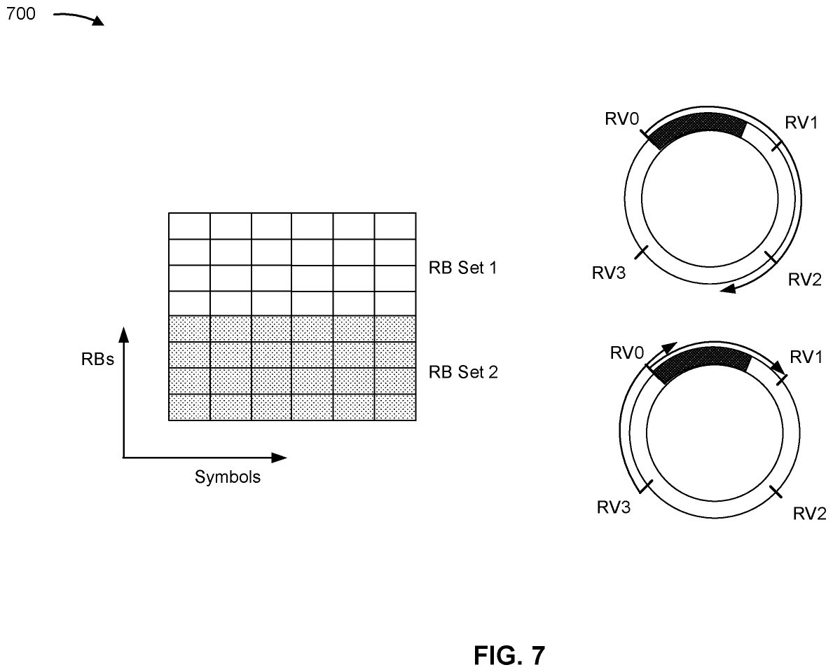

FIG. 7 is a diagram illustrating an example 700 of RV sequences, in accordance with the present disclosure.

Example 700 shows two sets of RBs for transmission of a TB, where the UE 120 transmits on each set of RBs using two RV sequences based on a configured RV sequence and an RV offset. For example, for an RV sequence of {0, 0} and an RV offset of 3, the UE 120 may transmit an initial transmission starting with RV=0 in a first transmission occasion (i.e., n=0) and another transmission using RV=0 in a second transmission occasion (i.e., n=1) with RB set 1 for the first TRP, and the UE 120 may transmit a transmission starting with RV=3 in a first transmission occasion (i.e., n=0) and another transmission using RV=3 in a second transmission occasion (i.e., n=1) with RB set 2 for the second TRP. The transmission occasions may include active CG occasions 505 as shown in FIG. 5. For example, for an RV sequence of {0, 3} and a RV offset 1, the UE 120 may transmit an initial transmission starting with RV=0 in a first transmission occasion (i.e., n=0) and another transmission using RV=3 in a second transmission occasion (i.e., n=1) with RB set 1 for the first TRP, and the UE 120 may transmit an transmission starting with RV=1 in a first transmission occasion (i.e., n=0) and another transmission using RV-0 in a second transmission occasion (i.e., n=1) with RB set 2 for the second TRP.

In some aspects, the UE 120 may only start to transmit an initial PUSCH transmission of a TB only at transmission occasions based at least in part on an RV parameter (e.g., startingFromRV0) indicated by the base station 110. For type 1 CG or type 2 CG, the base station 110 may indicate an RV sequence for K repetitions of the TB. If startingFromRV0 is set to “on”, the UE 120 may transmit the initial transmission of the K repetitions of the TB if the configured RV sequence is {0 2 3 1}. That is, the UE 120 may start to transmit the initial transmission only at a transmission occasion with RV0 for any TRP. The UE 120 may transmit the initial transmission at any of the transmission occasions of the K repetitions that are associated with RV0 if the configured RV sequence is {0 3 0 3}. The UE 120 may transmit the initial transmission at any of the transmission occasions of the K repetitions if the configured RV sequence is {0,0,0,0}, except the last transmission occasion when K≥8. If startingFromRV0 is set to “off”, the initial transmission of the TB may only start at the first transmission occasion of the K repetitions.

In some aspects, the UE 120 may be configured for CG-PUSCH communications with multiple TRPs. However, the behavior of the UE 120 for type 1 or type 2 CG-PUSCH transmissions with multiple TRPs using RV sequences has not been specified. Without such definition, the base station 110 may have to blind decode (detect) for multiple TRPs at each transmission occasion. As a result, the base station 110 and the UE 120 may consume additional processing resources and signaling resources.

As indicated above, FIG. 7 is provided as an example. Other examples may differ from what is described with regard to FIG. 7.

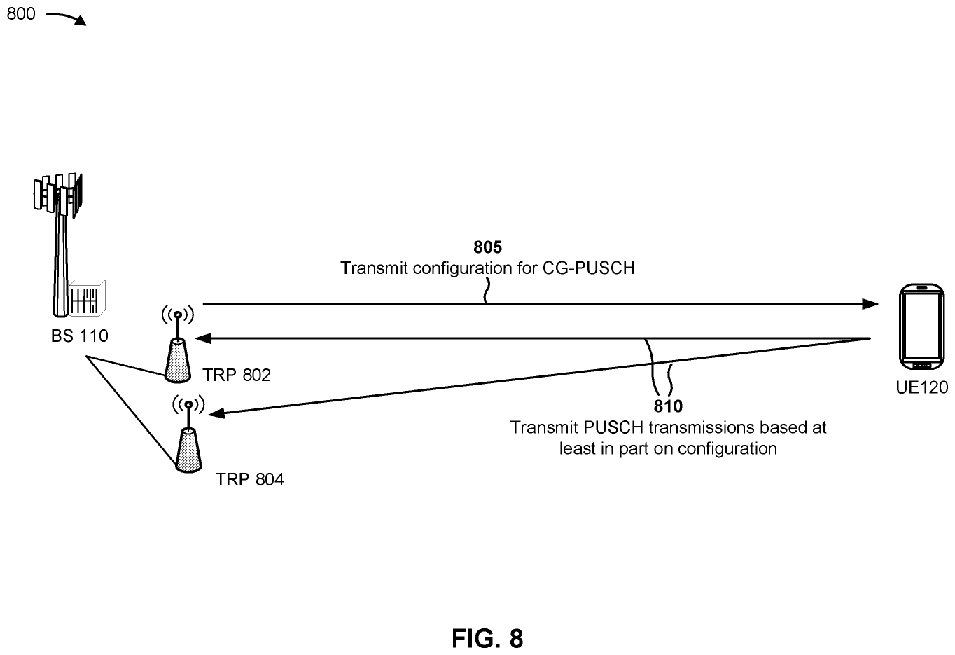

FIG. 8 is a diagram illustrating an example 800 of supporting CG-PUSCH transmissions with multiple TRPs for RV sequences, in accordance with the present disclosure. A base station (e.g., base station 110, access node 305) may control multiple TRPs (e.g., TRP 335, TRP 405, TRP 410), such as TRP 802 and TRP 804. In some aspects, TRP 802 or TRP 804 may be controlled by another base station or access node. The UE 120, the base station 110, TRP 802, and TRP 804 may communicate with one another.

According to various aspects described herein, if the UE 120 is configured for CG-PUSCH communications with multiple TRPs, the UE 120 may support a configuration of Type 1 or Type 2 CG-PUSCH transmissions for mTRP operations. The mTRP operations may include simultaneous PUSCH transmissions to multiple TRPs with FDMed or SDMed PUSCH transmissions. For example, the UE 120 may support configuration of the UE 120 with Type 1 or Type 2 CG-PUSCH transmissions using mTRP operations with FDMed or SDMed PUSCH transmissions for RV sequences and an RV offset. As shown by reference number 805, the base station 110 may transmit a configuration that configures the UE 120 for Type 1 or Type 2 CG-PUSCH communications for multiple TRPs. The RRC configuration for Type 1 CG-PUSCH or the activation DCI for Type 2 CG-PUSCH may indicate the resources for the CG-PUSCH communications for the multiple TRPs, including but not limited to a TDRA, an FDRA, a TCI indication, an RV sequence and RV offset, a periodicity, and/or a time offset. The RRC configuration for Type 1 CG-PUSCH and the activation DCI for Type 2 CG-PUSCH may be comparable to or equate to an sDCI. For each transmission of the CG-PUSCH, the UE 120 may transmit a TB to the multiple TRPs. The base station may transmit the configuration via TRP 802. As shown by reference number 810, the UE 120 may transmit FDMed or SDMed PUSCH transmissions based at least in part on the configuration.

In some aspects, the UE 120 may transmit the FDMed or SDMed PUSCH transmissions to the multiple TRPs for RV sequences. The configuration may include a configured RV sequence (via RRC parameter repK-RV). For example, if the PUSCH transmissions are FDMed with separate rate matching values at different frequency domain resource allocation parts, the UE 120 may apply the RV sequence separately for PUSCH transmissions to a first TRP and for PUSCH transmissions to a second TRP. The configuration may include an RV offset. The UE 120 may apply the configured RV sequence to transmission occasions associated with the first TRP and apply a RV sequence based on the configured RV sequence and the RV offset to transmission occasions associated with the second TRP. Applying the RV sequence may include using a starting RV for the first TRP and the RV offset for the second TRP.

For SDMed or FDMed mTRP PUSCHs with a single rate matching, the UE 120 may apply a single configured RV sequence (via repK-RV) to the PUSCH transmissions across the first and the second TRPs. For one transmission associated with multiple TRPs, the UE 120 may map the TB with a corresponding RV value consecutively to multiple TRPs.

Alternatively, for RV mapping of type 1 or type 2 CG based mTRP FDMed PUSCH transmission of separate rate matchings at different FDRA parts, if the UE 120 determines to transmit the initial transmission of a TB at a transmission occasion, the UE 120 may use one of several options (or aspects). As a first option, the UE 120 may transmit RVs (data corresponding to RVs) or codewords (coded data) to both the first TRP and the second TRP in the same transmission occasion. As a second option, the UE 120 may transmit only the RV or codeword that corresponds to the applicable TRP in the transmission occasion. This may include transmitting RVs or codewords to a single applicable TRP of the first TRP and the second TRP in the transmission occasion, and refraining from transmitting RVs or codewords to another TRP of the first TRP and the second TRP in the transmission occasion.

As a third option, the UE 120 may determine whether to use the first option or the second option based at least in part on an RRC configuration or one or more rules that the UE 120 follows. For example, the UE 120 may transmit the initial transmission of a TB using multiple TRPs (e.g., both TRP 802 and TRP 804) at a transmission occasion based at least in part on an RV parameter (e.g., startingfromRV0) and/or an RV sequence. In some aspects, if startingFromRV0 is set to “on”, the UE 120 may transmit the initial transmission of the TB using multiple TRPs at the first RV0 transmission occasion of any TRP if the configured RV sequence is {0, 2, 3, 1}. The UE 120 may transmit the initial transmission of the TB using multiple TRPs at any of the transmission occasions of the K repetitions that are associated with RV0 if the configured RV sequence is {0, 3, 0, 3}. The UE 120 may transmit the initial transmission of the TB using multiple TRPs at any of the transmission occasions of the K repetitions if the configured RV sequence is {0,0,0,0}, except the last transmission occasion when K≥8. If startingFromRV0 is set to “off”, the initial transmission of the TB may only start at the first transmission occasion of the K repetitions.

In some aspects, the base station 110 may follow the configuration or rule and decode the data for the specified RVs and TRPs in each applicable transmission occasion. In this way, the base station 110 performs less blind decoding at each transmission occasion. As a result, the base station 110 and the UE 120 may conserve processing resources and signaling resources with more efficient communications.

As indicated above, FIG. 8 is provided as an example. Other examples may differ from what is described with respect to FIG. 8.

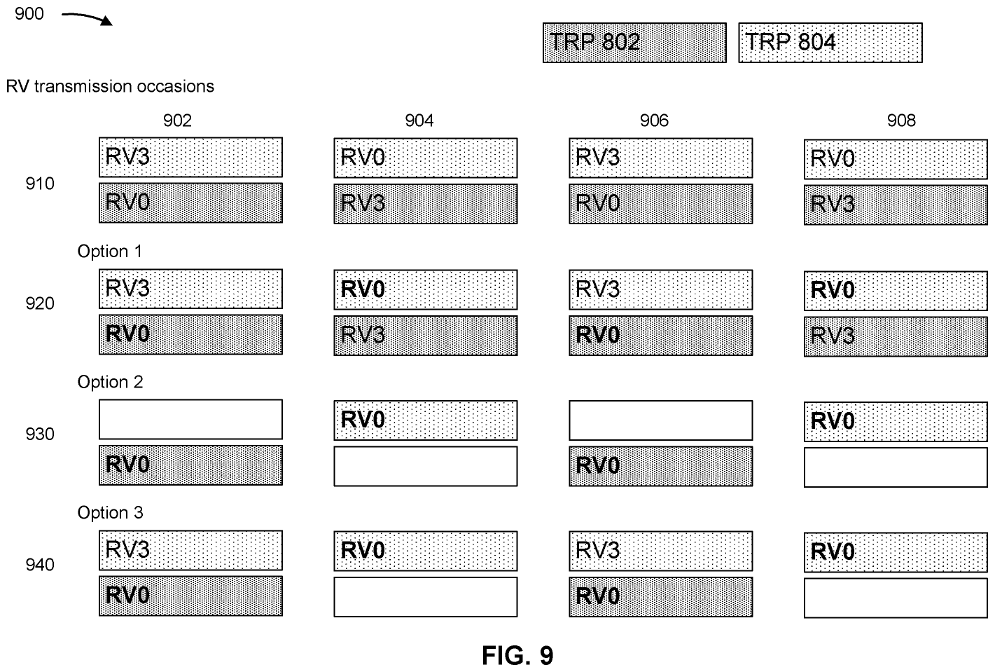

FIG. 9 is a diagram illustrating an example 900 of transmissions to TRPs in transmission occasions, in accordance with the present disclosure. Example 900 shows a first transmission occasion 902, a second transmission occasion 904, a third transmission occasion 906, and a fourth transmission occasion 908 for repetitions of a PUSCH transmission to TRP 802 and/or TRP 804 according to an RV sequence. In example 900, the RV sequence is {0, 3, 0, 3} and the RV offset is 3. Encoded bits of RV0 and RV3 may combine to form the full payload.

Row 910 shows available transmission occasions for the initial transmission of the TB according to the RV sequence {0, 3, 0, 3} applied to TRP 802 and the RV offset of 3 applied to TRP 804, if the UE 120 determines to transmit the initial transmission at any transmission occasion. Row 910 shows that the initial transmission to TRP 802 may start with RV0 in transmission occasion 902, RV3 in transmission occasion 904, RV0 in transmission occasion 906, and RV3 in transmission occasion 908. Row 910 also shows that an initial transmission to TRP 804 may start with RV3 in transmission occasion 902, RV0 in transmission occasion 904, RV3 in transmission occasion 906, and RV0 in transmission occasion 908.

Row 920 shows the first option, where the UE 120 may transmit the initial transmission for both RVs (encoded data corresponding to specific RVs) or codewords (encoded data) corresponding to different TRPs in the same transmission occasion. For example, the UE 120 may transmit the initial transmission with RV0 to TRP 802 and with RV3 to TRP 804 in transmission occasion 902, with RV3 to TRP 802 and with RV0 to TRP 804 in transmission occasion 904, with RV0 to TRP 802 and with RV3 to TRP 804 in transmission occasion 906, or with RV3 to TRP 802 and with RV0 to TRP 804 in transmission occasion 908. In this example, as shown in bold for row 920, the UE 120 transmits an initial transmission if RV0 in any of the transmission occasions. The other TRP then has an RV offset of 3 in the same transmission occasion.

In other words, the base station 110 may receive RVs from both TRPs simultaneously, decode the initial transmission for a specified TRP, and then use this decoding to decode the transmission received at the other TRP (no additional blind decoding) for the same payload with different rate matching. As a result, the base station 110 may receive the transmissions with greater reliability. Increased reliability conserves processing resources and signaling resources.

Row 930 shows the second option, wherein the UE 120 may transmit the initial transmission only for the RV or codeword corresponding to the applicable TRP in the transmission occasion (and not the other TRP). This may account for some latency at the UE 120 when the UE 120 does not have time to map encoded bits to resources for the second TRP. For example, the UE 120 may transmit the initial transmission only to TRP 802 (RV0) in transmission occasion 902, only for TRP 804 (RV0) in transmission occasion 904, only for TRP 802 (RV0) in transmission occasion 906, and only for TRP 804 (RV0) in transmission occasion 908.

By narrowing or restricting when the UE 120 is expected to transmit an initial transmission with RV0 (shown by bold RV0), the base station 110 may reduce the blind detection at each transmission occasion. The UE 120 may conserve processing resources by ignoring resource mapping for the other TRP.

Row 940 shows the third option, where the UE 120 may dynamically select either Option 1 or Option 2. For example, the UE 120 may transmit the initial transmission for either TRP 802 or TRP 804 in transmission occasion 902 (first option). However, the UE 120 may switch to the second option for transmission occasion 904, where the UE 120 may transmit the initial transmission to TRP 804 (RV0) and not TRP 802. The UE 120 may have determined that the UE 120 did not have time to map encoded bits to resources for TRP 802. The UE 120 may also select an option based on a previous configuration. The UE 120 may determine to use the first option for transmission occasion 906 and the second option for transmission occasion 908.

As indicated above, FIG. 9 is provided as an example. Other examples may differ from what is described with regard to FIG. 9.

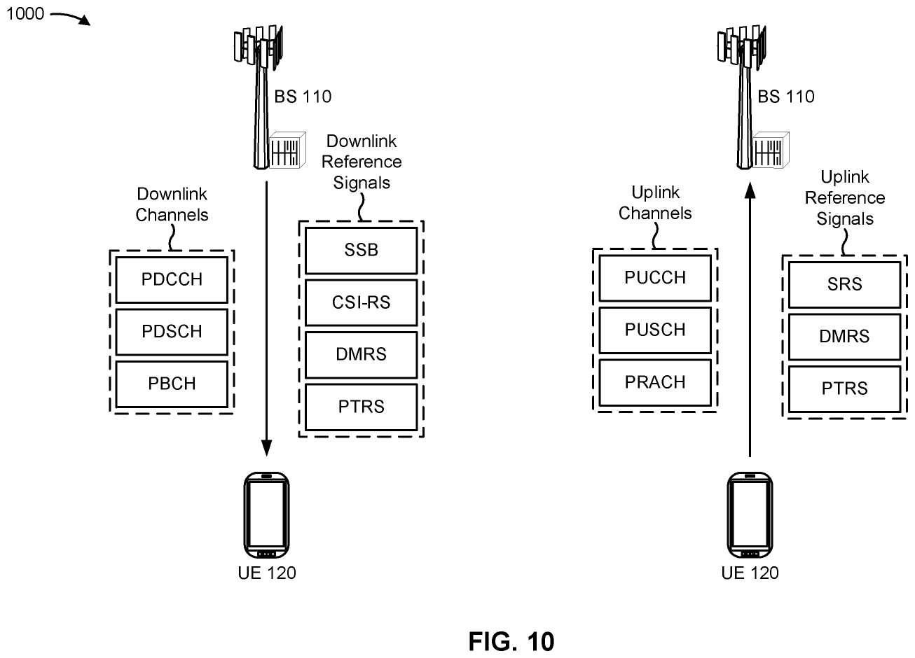

FIG. 10 is a diagram illustrating an example 1000 of physical channels and reference signals in a wireless network, in accordance with the present disclosure. As shown in FIG. 10, downlink channels and downlink reference signals may carry information from a base station 110 to a UE 120, and uplink channels and uplink reference signals may carry information from a UE 120 to a base station 110. Example 1000 is provided as context for further discussion about features associated with enabling the mTRP CG-PUSCH configuration for UE 120 with respect to antenna ports that are used for the PUSCH communications.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a PUSCH that carries uplink data, or a physical random access channel (PRACH) used for initial network access, among other examples. In some aspects, the UE 120 may transmit ACK or NACK feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI), a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A PRS may carry information used to enable timing or ranging measurements of the UE 120 based on signals transmitted by the base station 110 to improve observed time difference of arrival (OTDOA) positioning performance. An SRS may carry information used for uplink channel estimation, which may be used for scheduling, link adaptation, precoder selection, or beam management, among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A physical antenna may transmit information via a channel, and multiple physical antennas may transmit information via multiple channels. Such information may be conveyed via a logical antenna port, which may represent some combination of the physical antennas and/or channels. An antenna port may be defined such that a channel, over which a symbol on the antenna port is conveyed, can be inferred from a channel over which another symbol on the same antenna port is conveyed. In some aspects, antenna ports may be configured for DMRSs (DMRS ports) or for PTRSs (PTRS ports).

For a PUSCH corresponding to a configured grant Type 1 transmission, the UE 120 may assume an association between an uplink PTRS port and a DMRS port according to an indicated value. The value may correspond to a PTRS port as defined in a table (e.g., Table 7.3.1.1.2-25 or Table 7.3.1.1.1.2-26 in 3GPP Technical Specification (TS) 38.212). For example, for a first table, a value of 0 may indicate a first scheduled DMRS port, a value of 1 may indicate a second scheduled DMRS port, a value of 2 may indicate a third scheduled DMRS port, and a value of 3 may indicate a fourth scheduled DMRS port. PTRS ports may be associated with the DMRS ports, as indicated by a value. For a second table, a value may indicate whether a DMRS port shares a PTRS port. For example, a value of 0 in a most significant bit (MSB) may indicate that a first DMRS port shares PTRS port 0, and a value of 1 in the MSB may indicate that a second DMRS port shares PTRS port 0. A value of 0 in a least significant bit (LSB) may indicate that a first DMRS port shares PTRS port 1, and a value of 1 in the LSB may indicate that a second DMRS port shares PTRS port 1.

PUSCH antenna ports in indicated TPMI may share PTRS port 0, and PUSCH antenna ports in indicated TPMI may share PTRS port 1.

However, in type 1 CG (CG1) PUSCH, the strongest layer may change over time, and thus using a fixed DMRS port may not be appropriate for a layer. The PTRS port may be fixed at 0. Furthermore, for mTRP CG1 PUSCH, there may be two layers for different panels to the multiple TRPs and thus different PTRS ports are to be associated with DMRS ports.

As indicated above, FIG. 10 is provided as an example. Other examples may differ from what is described with regard to FIG. 10.

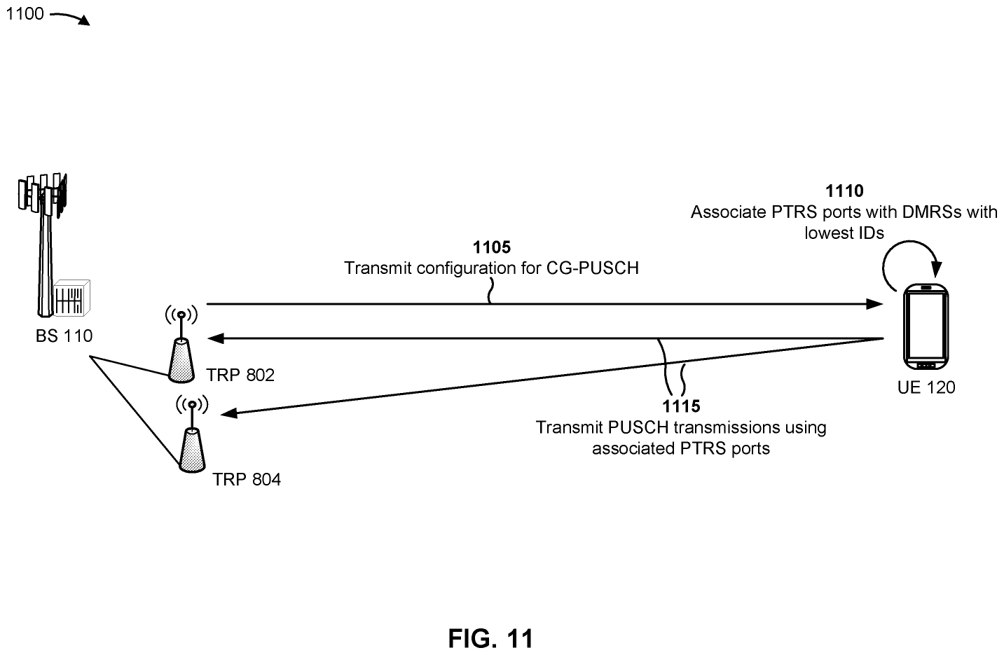

FIG. 11 is a diagram illustrating an example 1100 of associating PTRS ports with DMRS ports, in accordance with the present disclosure.

According to various aspects described herein, the UE 120 may have more flexibility in associating PTRS ports with DMRS ports. For example, in some aspects, as shown by reference number 1105, the base station 110 may transmit the configuration for CG-PUSCH communications, (e.g., type 1 CG-PUSCH, or CG1-PUSCH). As shown by reference number 1110, the UE 120 may associate one or more PTRS ports with one or more DMRS ports. For example, when the UE 120 is configured with CG1-PUSCH using mTRP simultaneous transmission, and capable of only one uplink PTRS port, the PTRS port for CG1-PUSCH may be associated with the scheduled DMRS port with the lowest ID (rather than always being tied to a fixed DMRS port 0). This may apply to SDMed or FDMed mTRP operations configured for CG1-PUSCH communications. For example, if DMRS port 2 and port 4 are scheduled for the CG1-PUSCH using m TRP simultaneous transmission, the PTRS port for CG1-PUSCH may be associated with the DMRS port 2.

In some aspects, when the UE 120 is configured with CG1-PUSCH using mTRP simultaneous transmission and capable of two uplink PTRS ports, for SDMed PUSCHs of two beams/TCIs, the UE 120 may associate two PTRS ports to the lowest indexed DMRS port among the DMRS ports corresponding to the first and second indicated beam or precoder (indicated by TCI or SRI), respectively. That is, different PTRS ports are associated with different beams because different beams are used for different TRPs. If there are multiple DMRS ports associated with different beams, the UE 120 may select the DMRS port with the lowest indexed DMRS port. For example, if DMRS port 0, port 1, and port 2 of different DMRS CDM groups are scheduled for the CG1-PUSCH using mTRP simultaneous transmission, the PTRS port 0 for CG1-PUSCH may be associated with the DMRS port 0, and the PTRS port 1 for CG1-PUSCH may be associated with the DMRS port 2, when DMRS port 0 and port 1 are associated with one DMRS CDM group and the DMRS port 2 are associated with another DMRS CDM group.

For example, if the UE 120 receives an DMRS antenna port indication of two DMRS code division multiplexing (CDM) groups and the two TCIs are each indicated per DMRS CDM group, the UE 120 may associate the two PTRS ports with two DMRS ports with the lowest ID within respective DMRS CDM groups. For FDMed PUSCHs of two beams/TCIs for different FDRA parts, if the UE receives an DMRS antenna port indication of one DMRS CDM group, the UE 120 may associate the two PTRS ports with the DMRS port with the lowest ID in different FDRA parts. For example, a first PTRS may be associated with PUSCH1, and a second PTRS may be associated with PUSCH2.

As shown by reference number 1115, the UE 120 may transmit PUSCH communications using the PTRS ports associated with the DMRSs with the lowest IDs.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120) performs operations associated with CG-PUSCH communications with multiple TRPs.

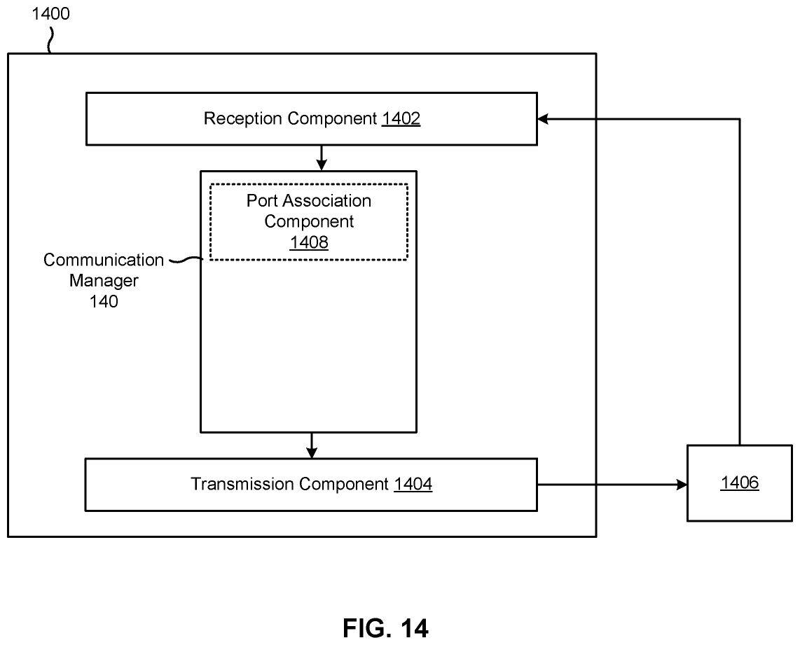

As shown in FIG. 12, in some aspects, process 1200 may include receiving a configuration that configures the UE for type 1 or type 2 CG-PUSCH communications for multiple TRPs (block 1210). For example, the UE (e.g., using communication manager 140 and/or reception component 1402 depicted in FIG. 14 may receive a configuration that configures the UE for type 1 or type 2 CG-PUSCH communications for multiple TRPs, as described above.

As further shown in FIG. 12, in some aspects, process 1200 may include transmitting FDMed or SDMed PUSCH transmissions based at least in part on the configuration (block 1220). For example, the UE (e.g., using communication manager 140 and/or transmission component 1404 depicted in FIG. 14) may transmit FDMed or SDMed PUSCH transmissions based at least in part on the configuration, as described above.

Process 1200 may include additional aspects, such as any single aspect or any combination of aspects described below and/or in connection with one or more other processes described elsewhere herein.

In a first aspect, transmitting the PUSCH transmissions includes transmitting the PUSCH transmissions based at least in part on an RV sequence.

In a second aspect, alone or in combination with the first aspect, transmitting the PUSCH transmissions includes, if the PUSCH transmissions are FDMed with separate rate matching values at different frequency domain resource allocation parts, applying the RV sequence separately for PUSCH transmissions to a first TRP and for PUSCH transmissions to a second TRP, and applying the RV sequence includes using a starting RV for the first TRP and an RV offset for the second TRP.

In a third aspect, alone or in combination with one or more of the first and second aspects, transmitting the PUSCH transmissions includes, if an initial transmission of a TB is to be transmitted in a transmission occasion, transmitting RVs or codewords to both the first TRP and the second TRP in the transmission occasion.

In a fourth aspect, alone or in combination with one or more of the first through third aspects, transmitting the PUSCH transmissions includes, if an initial transmission of a TB is to be transmitted in a transmission occasion transmitting RVs or codewords to a single applicable TRP of the first TRP and the second TRP in the transmission occasion, and refraining from transmitting RVs or codewords to another TRP of the first TRP and the second TRP in the transmission occasion.

In a fifth aspect, alone or in combination with one or more of the first through fourth aspects, transmitting the PUSCH transmissions includes, if an initial transmission of a transport block is to be transmitted in a transmission occasion, based at least in part on the configuration, a radio resource control configuration, a parameter value, or a rule transmitting RVs or codewords to both the first TRP and the second TRP in the transmission occasion, or transmitting RVs or codewords to a single applicable TRP of the first TRP and the second TRP in the transmission occasion and refraining from transmitting RVs or codewords corresponding to another TRP of the first TRP and the second TRP in the transmission occasion.

In a sixth aspect, alone or in combination with one or more of the first through fifth aspects, the rule specifies that the RVs or codewords are to be transmitted to both the first TRP and the second TRP based at least in part on the RV sequence and a value of an RV parameter.

In a seventh aspect, alone or in combination with one or more of the first through sixth aspects, transmitting the PUSCH transmissions includes, if the PUSCH transmissions are FDMed or SDMed with a single rate matching, applying the RV sequence for the PUSCH transmissions across a first TRP and a second TRP.

In an eighth aspect, alone or in combination with one or more of the first through seventh aspects, process 1200 includes associating a PTRS port with a DMRS port if the UE is capable of using no more than one uplink PTRS port.

In a ninth aspect, alone or in combination with one or more of the first through eighth aspects, the DMRS port has a lowest ID among DMRS ports.

In a tenth aspect, alone or in combination with one or more of the first through ninth aspects, process 1200 includes, if SDMed PUSCH communications are to be transmitted on two beams, associating a first PTRS port with a first DMRS port having a lowest ID and a second PTRS port with a second DMRS port having a next lowest ID.

In an eleventh aspect, alone or in combination with one or more of the first through tenth aspects, process 1200 includes, if FDMed PUSCH communications are to be transmitted on two beams, and if a DMRS port indication of one DMRS code division multiplexing group is received, associating a first PTRS port with a first DMRS port having a lowest ID in a first FDRA part and a second PTRS port with a second DMRS port having a lowest ID in a second FDRA part.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a base station, in accordance with the present disclosure. Example process 1300 is an example where the base station (e.g., base station 110) performs operations associated with CG-PUSCH communications with multiple TRPs.

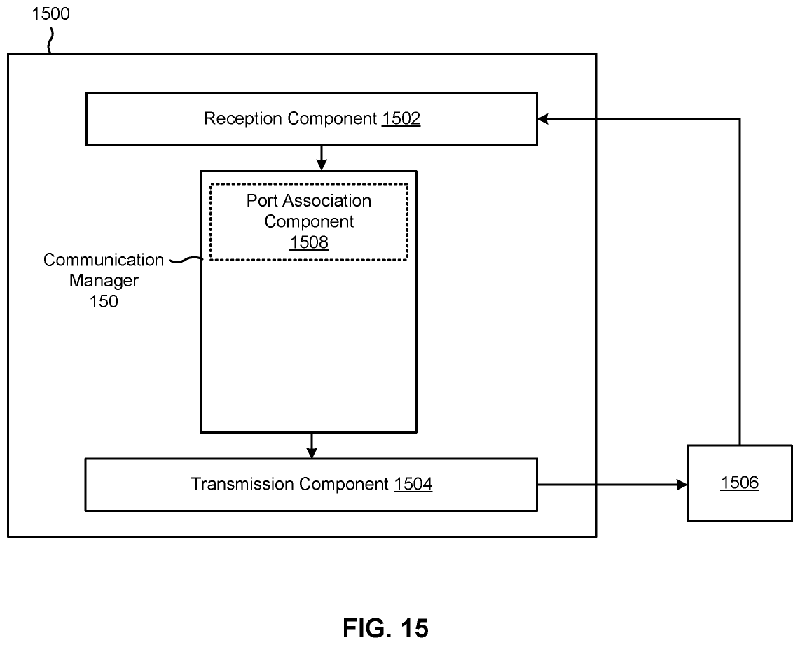

As shown in FIG. 13, in some aspects, process 1300 may include transmitting, to a UE, a configuration that configures the UE for type 1 or type 2 CG-PUSCH communications for multiple TRPs (block 1310). For example, the base station (e.g., using communication manager 150 and/or transmission component 1504 depicted in FIG. 15) may transmit, to a UE, a configuration that configures the UE for type 1 or type 2 CG-PUSCH communications for multiple TRPs, as described above.

As further shown in FIG. 13, in some aspects, process 1300 may include receiving, at one or more of a first TRP or a second TRP of the base station, FDMed or SDMed PUSCH transmissions based at least in part on the configuration (block 1320). For example, the base station (e.g., using communication manager 150 and/or reception component 1502 depicted in FIG. 15) may receive, at one or more of a first TRP or a second TRP of the base station, FDMed or SDMed PUSCH transmissions based at least in part on the configuration, as described above.

Process 1300 may include additional aspects, such as any single aspect or any combination of aspects described below and/or in connection with one or more other processes described elsewhere herein.

In a first aspect, the PUSCH transmissions are based at least in part on an RV sequence.

In a second aspect, alone or in combination with the first aspect, receiving the PUSCH transmissions includes, if the PUSCH transmissions are FDMed with separate rate matchings at different frequency domain resource allocation parts, decoding the PUSCH transmissions using the RV sequence separately for PUSCH transmissions to the first TRP and for PUSCH transmissions to the second TRP, and process 1300 further includes decoding the PUSCH transmissions to the first TRP using a starting RV and decoding the PUSCH transmissions to the second TRP using an RV offset.

In a third aspect, alone or in combination with one or more of the first and second aspects, receiving the PUSCH transmissions includes, if an initial transmission of a transport block is to be received in a transmission occasion, receiving RVs or codewords at both the first TRP and the second TRP in the transmission occasion.

In a fourth aspect, alone or in combination with one or more of the first through third aspects, receiving the PUSCH transmissions includes, if an initial transmission of a transport block is to be received in a transmission occasion, receiving RVs or codewords at a single applicable TRP of the first TRP and the second TRP in the transmission occasion.

In a fifth aspect, alone or in combination with one or more of the first through fourth aspects, receiving the PUSCH transmissions includes blinding decoding at the single applicable TRP, and refraining from blind decoding at another TRP of the first TRP and the second TRP in the transmission occasion.

In a sixth aspect, alone or in combination with one or more of the first through fifth aspects, receiving the PUSCH transmissions includes, if the PUSCH transmissions are FDMed or SDMed with a single rate matching, decoding the PUSCH transmissions at the first TRP and the second TRP based at least in part on the RV sequence.

In a seventh aspect, alone or in combination with one or more of the first through sixth aspects, process 1300 includes associating a PTRS port with a DMRS port if the UE is capable of using no more than one uplink PTRS port.

In an eighth aspect, alone or in combination with one or more of the first through seventh aspects, the DMRS port has a lowest ID among DMRS ports.

In a ninth aspect, alone or in combination with one or more of the first through eighth aspects, process 1300 includes, if SDMed PUSCH communications are to be transmitted by the UE on two beams, associating a first PTRS port with a first DMRS port having a lowest ID and a second PTRS port with a second DMRS port having a next lowest ID.

In a tenth aspect, alone or in combination with one or more of the first through ninth aspects, process 1300 includes, if FDMed PUSCH communications are to be transmitted by the UE on two beams, and if a DMRS port indication of one DMRS code division multiplexing group is transmitted, associating a first PTRS port with a first DMRS port having a lowest identifier in a first FDRA part and a second PTRS port with a second DMRS port having a lowest identifier in a second FDRA part.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE (e.g. a UE 120), or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a port association component 1408, among other examples.

In some aspects, the apparatus 1400 may be configured to perform one or more operations described herein in connection with FIGS. 1-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive a configuration that configures the UE for type 1 or type 2 CG-PUSCH communications for multiple TRPs. The transmission component 1404 may transmit FDMed or SDMed PUSCH transmissions based at least in part on the configuration.

The port association component 1408 may associate a PTRS port with a DMRS port if the UE is capable of using no more than one uplink PTRS port.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a base station (e.g., base station 110), or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a port association component 1508, among other examples.

In some aspects, the apparatus 1500 may be configured to perform one or more operations described herein in connection with FIGS. 1-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the base station described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the base station described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the base station described in connection with FIG. 2. In some aspects, the transmission component 1504 may be co-located with the reception component 1502 in a transceiver.

The transmission component 1504 may transmit, to a UE (e.g., apparatus 1506), a configuration that configures the UE for type 1 or type 2 CG-PUSCH communications for multiple TRPs. The reception component 1502 may receive, at one or more of a first TRP or a second TRP of the base station, FDMed or SDMed PUSCH transmissions based at least in part on the configuration.

The port association component 1508 may associate a PTRS port with a DMRS port if the UE is capable of using no more than one uplink PTRS port.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a user equipment (UE), comprising: receiving a configuration that configures the UE for type 1 or type 2 configured grant physical uplink shared channel (CG-PUSCH) communications for multiple transmit receive points (TRPs); and transmitting frequency division multiplexed (FDMed) or spatial division multiplexed (SDMed) PUSCH transmissions based at least in part on the configuration.
Aspect 2: The method of Aspect 1, wherein transmitting the PUSCH transmissions includes transmitting the PUSCH transmissions based at least in part on a redundancy version (RV) sequence.
Aspect 3: The method of Aspect 2, wherein transmitting the PUSCH transmissions includes, if the PUSCH transmissions are FDMed with separate rate matching values at different frequency domain resource allocation parts, applying the RV sequence separately for PUSCH transmissions to a first TRP and for PUSCH transmissions to a second TRP, and wherein applying the RV sequence includes using a starting RV for the first TRP and an RV offset for the second TRP.
Aspect 4: The method of Aspect 3, wherein transmitting the PUSCH transmissions includes, if an initial transmission of a transport block is to be transmitted in a transmission occasion, transmitting RVs or codewords to both the first TRP and the second TRP in the transmission occasion.
Aspect 5: The method of Aspect 3, wherein transmitting the PUSCH transmissions includes, if an initial transmission of a transport block is to be transmitted in a transmission occasion: transmitting RVs or codewords to a single applicable TRP of the first TRP and the second TRP in the transmission occasion; and refraining from transmitting RVs or codewords to another TRP of the first TRP and the second TRP in the transmission occasion.
Aspect 6: The method of Aspect 3, wherein transmitting the PUSCH transmissions includes, if an initial transmission of a transport block is to be transmitted in a transmission occasion, based at least in part on the configuration, a radio resource control configuration, a parameter value, or a rule: transmitting RVs or codewords to both the first TRP and the second TRP in the transmission occasion; or transmitting RVs or codewords to a single applicable TRP of the first TRP and the second TRP in the transmission occasion and refraining from transmitting RVs or codewords corresponding to another TRP of the first TRP and the second TRP in the transmission occasion.
Aspect 7: The method of Aspect 6, wherein the rule specifies that the RVs or codewords are to be transmitted to both the first TRP and the second TRP based at least in part on the RV sequence and a value of an RV parameter.
Aspect 8: The method of Aspect 2, wherein transmitting the PUSCH transmissions includes, if the PUSCH transmissions are FDMed or SDMed with a single rate matching, applying the RV sequence for the PUSCH transmissions across a first TRP and a second TRP.
Aspect 9: The method of any of Aspects 1-8, further comprising associating a phase tracking reference signal (PTRS) port with a demodulation reference signal (DMRS) port if the UE is capable of using no more than one uplink PTRS port.
Aspect 10: The method of Aspect 9, wherein the DMRS port has a lowest identifier among DMRS ports.
Aspect 11: The method of any of Aspects 1-8, further comprising, if SDMed PUSCH communications are to be transmitted on two beams, associating a first phase tracking reference signal (PTRS) port with a first demodulation reference signal (DMRS) port having a lowest identifier and a second PTRS port with a second DMRS port having a next lowest identifier.
Aspect 12: The method of any of Aspects 1-8, further comprising, if FDMed PUSCH communications are to be transmitted on two beams, and if a demodulation reference signal (DMRS) port indication of one DMRS code division multiplexing group is received, associating a first phase tracking reference signal (PTRS) port with a first DMRS port having a lowest identifier in a first frequency domain resource allocation (FDRA) part and a second PTRS port with a second DMRS port having a lowest identifier in a second FDRA part.
Aspect 13: A method of wireless communication performed by a base station, comprising: transmitting, to a user equipment (UE), a configuration that configures the UE for type 1 or type 2 configured grant physical uplink shared channel (CG-PUSCH) communications for multiple transmit receive points (TRPs); and receiving, at one or more of a first TRP or a second TRP of the base station, frequency division multiplexed (FDMed) or spatial division multiplexed (SDMed) PUSCH transmissions based at least in part on the configuration.
Aspect 14: The method of Aspect 13, wherein the PUSCH transmissions are based at least in part on a redundancy version (RV) sequence.
Aspect 15: The method of Aspect 14, wherein receiving the PUSCH transmissions includes, if the PUSCH transmissions are FDMed with separate rate matchings at different frequency domain resource allocation parts, decoding the PUSCH transmissions using the RV sequence separately for PUSCH transmissions to the first TRP and for PUSCH transmissions to the second TRP, and wherein the method further comprises: decoding the PUSCH transmissions to the first TRP using a starting RV; and decoding the PUSCH transmissions to the second TRP using an RV offset.
Aspect 16: The method of Aspect 15, wherein receiving the PUSCH transmissions includes, if an initial transmission of a transport block is to be received in a transmission occasion, receiving RVs or codewords at both the first TRP and the second TRP in the transmission occasion.
Aspect 17: The method of Aspect 15, wherein receiving the PUSCH transmissions includes, if an initial transmission of a transport block is to be received in a transmission occasion, receiving RVs or codewords at a single applicable TRP of the first TRP and the second TRP in the transmission occasion.
Aspect 18: The method of Aspect 17, wherein receiving the PUSCH transmissions includes: blind decoding at the single applicable TRP; and refraining from blind decoding at another TRP of the first TRP and the second TRP in the transmission occasion.
Aspect 19: The method of Aspect 14, wherein receiving the PUSCH transmissions includes, if the PUSCH transmissions are FDMed or SDMed with a single rate matching, decoding the PUSCH transmissions at the first TRP and the second TRP based at least in part on the RV sequence.
Aspect 20: The method of any of Aspects 13-19, further comprising associating a phase tracking reference signal (PTRS) port with a demodulation reference signal (DMRS) port if the UE is capable of using no more than one uplink PTRS port.
Aspect 21: The method of Aspect 20, wherein the DMRS port has a lowest identifier among DMRS ports.
Aspect 22: The method of any of Aspects 13-19, further comprising, if SDMed PUSCH communications are to be transmitted by the UE on two beams, associating a first phase tracking reference signal (PTRS) port with a first demodulation reference signal (DMRS) port having a lowest identifier and a second PTRS port with a second DMRS port having a next lowest identifier.
Aspect 23: The method of any of Aspects 13-19, further comprising, if FDMed PUSCH communications are to be transmitted by the UE on two beams, and if a demodulation reference signal (DMRS) port indication of one DMRS code division multiplexing group is transmitted, associating a first phase tracking reference signal (PTRS) port with a first DMRS port having a lowest identifier in a first frequency domain resource allocation (FDRA) part and a second PTRS port with a second DMRS port having a lowest identifier in a second FDRA part.
Aspect 24: An apparatus for wireless communication at a device, comprising a processor; memory coupled with the processor; and instructions stored in the memory and executable by the processor to cause the apparatus to perform the method of one or more of Aspects 1-23.
Aspect 25: A device for wireless communication, comprising a memory and one or more processors coupled to the memory, the one or more processors configured to perform the method of one or more of Aspects 1-23.
Aspect 26: An apparatus for wireless communication, comprising at least one means for performing the method of one or more of Aspects 1-23.
Aspect 27: A non-transitory computer-readable medium storing code for wireless communication, the code comprising instructions executable by a processor to perform the method of one or more of Aspects 1-23.
Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a configuration that configures the UE for type 1 or type 2 configured grant physical uplink shared channel (CG-PUSCH) communications for multiple transmit receive points (TRPs); and
transmit frequency division multiplexed (FDMed) or spatial division multiplexed (SDMed) PUSCH transmissions based at least in part on the configuration.

2. The UE of claim 1, wherein the one or more processors, to transmit the PUSCH transmissions, are configured to transmit the PUSCH transmissions based at least in part on a redundancy version (RV) sequence.

3. The UE of claim Error! Reference source not found, wherein transmitting the one or more processors, to transmit the PUSCH transmissions includes, are configured to, if the PUSCH transmissions are FDMed with separate rate matching values at different frequency domain resource allocation parts, applying apply the RV sequence separately for PUSCH transmissions to a first TRP and for PUSCH transmissions to a second TRP, and wherein applying the one or more processors, to apply the RV sequence, are configured to includes using use a starting RV for the first TRP and an RV offset for the second TRP.

4. The UE of claim 3, wherein the one or more processors, to transmit the PUSCH transmissions, are configured to, if an initial transmission of a transport block is to be transmitted in a transmission occasion, transmit RVs or codewords to both the first TRP and the second TRP in the transmission occasion.

5. The UE of claim 3, wherein the one or more processors, to transmit the PUSCH transmissions, are configured to, if an initial transmission of a transport block is to be transmitted in a transmission occasion:
transmit RVs or codewords to a single applicable TRP of the first TRP and the second TRP in the transmission occasion; and
refrain from transmitting RVs or codewords to another TRP of the first TRP and the second TRP in the transmission occasion.

6. The UE of claim 3, wherein the one or more processors, to transmit the PUSCH transmissions, are configured to, if an initial transmission of a transport block is to be transmitted in a transmission occasion, based at least in part on the configuration, a radio resource control configuration, a parameter value, or a rule:
transmit RVs or codewords to both the first TRP and the second TRP in the transmission occasion; or
transmit RVs or codewords to a single applicable TRP of the first TRP and the second TRP in the transmission occasion and refraining from transmitting RVs or codewords corresponding to another TRP of the first TRP and the second TRP in the transmission occasion.

7. The UE of claim 6, wherein the rule specifies that the RVs or codewords are to be transmitted to both the first TRP and the second TRP based at least in part on the RV sequence and a value of an RV parameter.

8. The UE of claim 2, wherein the one or more processors, to transmit the PUSCH transmissions, are configured to, if the PUSCH transmissions are FDMed or SDMed with a single rate matching, apply the RV sequence for the PUSCH transmissions across a first TRP and a second TRP.

9. The UE of claim 1, wherein the one or more processors are further configured to associate a phase tracking reference signal (PTRS) port with a demodulation reference signal (DMRS) port if the UE is capable of using no more than one uplink PTRS port.

10. The UE of claim 9, wherein the DMRS port has a lowest identifier among DMRS ports.

11. The UE of claim 1, wherein the one or more processors are further configured to, if SDMed PUSCH communications are to be transmitted on two beams, associate a first phase tracking reference signal (PTRS) port with a first demodulation reference signal (DMRS) port having a lowest identifier and a second PTRS port with a second DMRS port having a next lowest identifier.

12. The UE of claim 1, wherein the one or more processors are further configured to, if FDMed PUSCH communications are to be transmitted on two beams, and if a demodulation reference signal (DMRS) port indication of one DMRS code division multiplexing group is received, associate a first phase tracking reference signal (PTRS) port with a first DMRS port having a lowest identifier in a first frequency domain resource allocation (FDRA) part and a second PTRS port with a second DMRS port having a lowest identifier in a second FDRA part.

13. A base station for wireless communication, comprising:
a memory; and
one or more processors, coupled to the memory, configured to:
transmit, to a user equipment (UE), a configuration that configures the UE for type 1 or type 2 configured grant physical uplink shared channel (CG-PUSCH) communications for multiple transmit receive points (TRPs); and
receive, at one or more of a first TRP or a second TRP of the base station, frequency division multiplexed (FDMed) or spatial division multiplexed (SDMed) PUSCH transmissions based at least in part on the configuration.

14. The base station of claim 13, wherein the PUSCH transmissions are based at least in part on a redundancy version (RV) sequence.

15. The base station of claim Error! Reference source not found, wherein the one or more processors, to receive the PUSCH transmissions, are configured to, if the PUSCH transmissions are FDMed with separate rate matchings at different frequency domain resource allocation parts, decoding decode the PUSCH transmissions using the RV sequence separately for PUSCH transmissions to the first TRP and for PUSCH transmissions to the second TRP, and wherein the one or more processors are configured to:
decode the PUSCH transmissions to the first TRP using a starting RV; and
decode the PUSCH transmissions to the second TRP using an RV offset.

16. The base station of claim 15, wherein the one or more processors, to receive the PUSCH transmissions, are configured to, if an initial transmission of a transport block is to be received in a transmission occasion, receive RVs or codewords at both the first TRP and the second TRP in the transmission occasion.

17. The base station of claim 15, wherein the one or more processors, to receive the PUSCH transmissions, are configured to, if an initial transmission of a transport block is to be received in a transmission occasion, receive RVs or codewords at a single applicable TRP of the first TRP and the second TRP in the transmission occasion.

18. The base station of claim 17, wherein the one or more processors, to receive the PUSCH transmissions, are configured to:
blind decode at the single applicable TRP; and
refrain from blind decoding at another TRP of the first TRP and the second TRP in the transmission occasion.

19. The base station of claim 14, wherein the one or more processors, to receive the PUSCH transmissions, are configured to, if the PUSCH transmissions are FDMed or SDMed with a single rate matching, decode the PUSCH transmissions at the first TRP and the second TRP based at least in part on the RV sequence.

20. The base station of claim 13, wherein the one or more processors are further configured to associate a phase tracking reference signal (PTRS) port with a demodulation reference signal (DMRS) port if the UE is capable of using no more than one uplink PTRS port.

21. The base station of claim 20, wherein the DMRS port has a lowest identifier among DMRS ports.

22. The base station of claim 13, wherein the one or more processors are further configured to, if SDMed PUSCH communications are to be transmitted by the UE on two beams, associate a first phase tracking reference signal (PTRS) port with a first demodulation reference signal (DMRS) port having a lowest identifier and a second PTRS port with a second DMRS port having a next lowest identifier.

23. The base station of claim 13, wherein the one or more processors are further configured to, if FDMed PUSCH communications are to be transmitted by the UE on two beams, and if a demodulation reference signal (DMRS) port indication of one DMRS code division multiplexing group is transmitted, associate a first phase tracking reference signal (PTRS) port with a first DMRS port having a lowest identifier in a first frequency domain resource allocation (FDRA) part and a second PTRS port with a second DMRS port having a lowest identifier in a second FDRA part.

24. A method of wireless communication performed by a user equipment (UE), comprising:
receiving a configuration that configures the UE for type 1 or type 2 configured grant physical uplink shared channel (CG-PUSCH) communications for multiple transmit receive points (TRPs); and
transmitting frequency division multiplexed (FDMed) or spatial division multiplexed (SDMed) PUSCH transmissions based at least in part on the configuration.

25. The method of claim 24, wherein transmitting the PUSCH transmissions includes transmitting the PUSCH transmissions based at least in part on a redundancy version (RV) sequence.

26. The method of claim 25, wherein transmitting the PUSCH transmissions includes, if the PUSCH transmissions are FDMed with separate rate matching values at different frequency domain resource allocation parts, applying the RV sequence separately for PUSCH transmissions to a first TRP and for PUSCH transmissions to a second TRP, and wherein applying the RV sequence includes using a starting RV for the first TRP and an RV offset for the second TRP.

27. The method of claim 26, wherein transmitting the PUSCH transmissions includes, if an initial transmission of a transport block is to be transmitted in a transmission occasion, transmitting RVs or codewords to both the first TRP and the second TRP in the transmission occasion.

28. The method of claim 26, wherein transmitting the PUSCH transmissions includes, if an initial transmission of a transport block is to be transmitted in a transmission occasion:
transmitting RVs or codewords to a single applicable TRP of the first TRP and the second TRP in the transmission occasion; and
refraining from transmitting RVs or codewords to another TRP of the first TRP and the second TRP in the transmission occasion.

29. The method of claim 26, wherein transmitting the PUSCH transmissions includes, if an initial transmission of a transport block is to be transmitted in a transmission occasion, based at least in part on the configuration, a radio resource control configuration, a parameter value, or a rule:
transmitting RVs or codewords to both the first TRP and the second TRP in the transmission occasion; or
transmitting RVs or codewords to a single applicable TRP of the first TRP and the second TRP in the transmission occasion and refraining from transmitting RVs or codewords corresponding to another TRP of the first TRP and the second TRP in the transmission occasion.

30. The method of claim 24, further comprising associating a phase tracking reference signal (PTRS) port with a demodulation reference signal (DMRS) port if the UE is capable of using no more than one uplink PTRS port.
